(19) United States
(12) Patent Application Publication
(10) Pub. No.: US 2014/0318658 A1
(43) Pub. Date: Oct. 30, 2014

(54) Useful Life of Permeation Devices

(71) Applicant: Ramesh Chand, Chino Hills, CA (US)

(72) Inventor: Ramesh Chand, Chino Hills, CA (US)

(73) Assignee: REAL SENSORS, INC.

(21) Appl. No.: 13/871,509

(22) Filed: Apr. 26, 2013

(51) Int. Cl. F16L 9/127

(52) U.S. Cl. CPC F16L 9/127
USPC 138/109; 156/86

(57) ABSTRACT

Sheath systems 20, 40 are attached to the chemical emitting ends of permeation devices or permeation tubes 10, 30 to retard the release of stored chemicals before the intended use of the improved permeation devices. Sheath systems may be made of polyolefin material, Fluorinated ethylene propylene (FEP) resin or other material in a heat shrink configuration wherein heat is applied to contract, shrink wrap or otherwise secure the sheath to a permeation tube. At the time of intended use, the sheath assembly may be removed without damage to the permeation device.

### BACKGROUND OF THE INVENTION

(1) Field of the Invention

The invention generally relates to permeating devices. More particularly, the invention relates to means and methods of extending the useful life of permeation devices.

(2) Description of the Related Art

Gas permeation devices in general are known in the related art. For example, U.S. Pat. No. 7,663,099 issued to Reda on Feb. 16, 2010 discloses a permeation tube, FIG. 2 and FIG. 3 used with an ion mobility spectrometry (IMS) system. A gas permeable tube is used as an ammonia gas generation device.

U.S. Published Patent Application 2011/0240838 by Debono et al, published on Oct. 6, 2011 discloses an ion mobility spectrometry system using a permeation tube, FIG. 1 with the permeation tube containing ammonia gas.

U.S. Published Patent Application 2012/0298856 by Burton et al, published on Nov. 29, 2012 discloses a multi chambered dopant permeation tube used in ammonia and dichloromethane (DCM) spectrometry systems.

In general, permeation devices, such as permeation tubes and cylinders are often used for the testing and calibration of sophisticated sensing instruments, such as ion mobility spectrometers (IMS) and ion trap Mobility spectrometers (ITMS). Such instruments are sometimes used to detect explosives, narcotics and pollutants in various applications. Systems detecting explosives and narcotics are often used at airports and shipyards and are often used by law enforcement, the military and the home security industry.

Permeation devices are sometimes used as Dopant devices in ion mobility spectroscopy (IMS) based instruments. A permeation device, containing chemical Dichloromethane (DCM), is frequently used as a Negative Ion Dopant in IMS based instruments for the detection of explosives. Such a permeation device is also known by its OEM P/N MP005810. Another permeation device, containing chemical, Ammonium Carbamate, is sometimes used as a Positive Ion Dopant in the detection of narcotics. This permeation device is sometimes known by its OEM P/N MP035087.

The permeation devices described above are severely limited in the amount of chemicals they may contain due primarily to safety restrictions imposed in shipping hazardous chemicals. The chemical payload is also restricted by the gross size of a permeation tube, which is designed to fit into compact spectrometry systems suitable for portable field use. Thus, making the permeation tubes larger is not a viable option.

The short useful life of permeation devices in the prior art is a serious setback to the art. Prior art permeation devices are now releasing Dopant material continuously, even during storage and shipment. Long delays in use caused by shipment, especially overseas, and extended storage times, have greatly diminished the useful life of permeation devices. Consumers of prior art permeation devices are currently instructed to freeze the devices, an option that is expensive and requires a warm up period to effectively use the devices. Thus, there is a need in the art for new means and methods of extending the useful life of permeation devices.

### BRIEF SUMMARY OF THE INVENTION

The present invention overcomes shortfalls in the related art by presenting an unobvious and unique combination, configuration and use of chemical compounds, coverings, methods and materials that are far better than the current option of freezing permeation devices. A new membrane, membrane system and related methods are disclosed with have provided unexpected results in doubling of useful life of permeation devices.

The disclosures herein could not be found with normal experimentation and may not be considered obvious as the prior art teaches freezing to extend useful life. The prior art eschews any wrapping or other direct contact with a permeation tube, which is in direct contraction to the presently disclosed embodiments.

In one disclosed embodiment, a film or membrane of Fluorinated ethylene propylene (FEP) resin is applied to the outside of a permeation device at the time the permeation device is manufactured. In another embodiment, a sheath, film or membrane of polyolefin is applied to the outside of a permeation device at the time of manufacture. A cap or sheath assembly may also take the form of a preformed enclosure made from polyolefin or other material. In the preferred embodiment, a permeation device, such as a Dopant device, having an approximate outside diameter (O.D.) of 0.312 inches is enclosed within a heat-shrink polyolefin film having an O.D. of approximately 0.356 inches. The film is then heated to approximately 350 F to artfully contract or shrink the film, cap or cover material to achieve a firm but non-damaging attachment. Other materials and methods are contemplated and disclosed herein.

In another disclosed embodiment, a Dopant to test for explosives is sheathed in an extended cylinder to diminish off gassing before use.

### BRIEF DESCRIPTION OF THE DRAWINGS

FIG. 1 is a perspective view of a disclosed wrap system applied upon a permeation device of Ammonia Crystal

FIG. 2 is a perspective view of a prior art permeation device of Ammonia Crystal.

FIG. 3 is a perspective view of a disclosed wrap system applied upon a permeation device

FIG. 4 is a perspective view of a disclosed wrap system applied upon a permeation device of Dichloromethane

FIG. 5 is a perspective view of a prior art permeation device of Dichloromethane

FIG. 6 is a perspective view of a disclosed wrap system

FIG. 7 is a perspective view of a prior art permeation device

### REFERENCE NUMERALS IN THE DRAWINGS

10 a permeation tube, sometimes containing Ammonia Crystal

20 a permeation tube closure system, sometimes comprising a sheath assembly

21 body of sheath assembly 20

22 distal shoulder of sheath assembly 20

24 distal cap of sheath assembly 20

25 proximal shoulder of sheath assembly 20

30 a permeation tube, sometimes containing Dichloromethane

40 a disclosed sheath system sometimes used upon a permeation device containing Dichloromethane

200 a permeation tube of the prior art

300 a permeation tube of the prior art

These and other aspects of the present invention will become apparent upon reading the following detailed description in conjunction with the associated drawings.

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

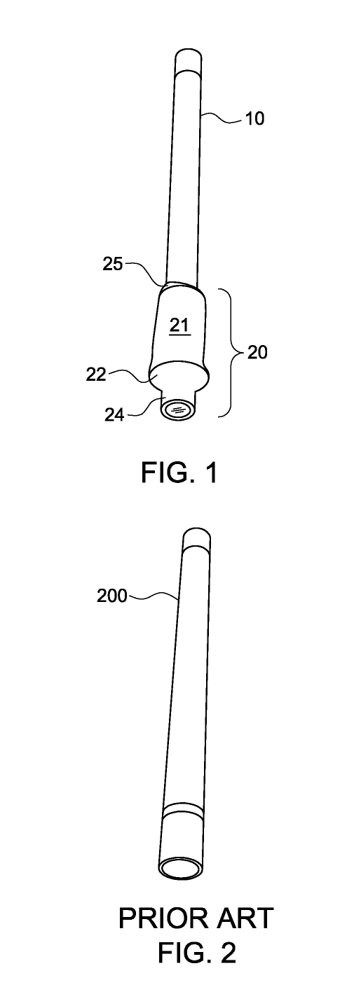

FIG. 1 depicts a disclosed sheath assembly 20 affixed to a permeation tube 10. The sheath assembly 20 may be comprised of polyolefin or Fluorinated ethylene propylene (FEP) resin applied to a permeation device at the time of manufacture or after. The sheath assembly 20, made from polyolefin, FEP or other material may take a liquid form before application, or may be applied as a solid membrane. In order to dry or shrink a sheath assembly, heat in the range of 200 to 450 degrees may be applied. The sheath assembly 20 may provide a solid cap around and over a permeation device.

A sheath assembly may comprise any form of shrink wrap or liquid applied membrane and may be comprised of any material. In one embodiment, a sheath assembly 20 is applied to a permeation tube 10, the permeation tube sometimes containing Ammonia Crystal. A sheath assembly may comprise a body 21, sometimes taking the form of a cylinder. The sheath assembly 20 may further comprise a proximal shoulder 25, providing a transition between the body 21 and permeation tube 10.

A sheath assembly may further comprise a distal shoulder 22, providing a transition between the body 21 and a distal cap 24.

FIG. 2 depicts a prior art tube 200.

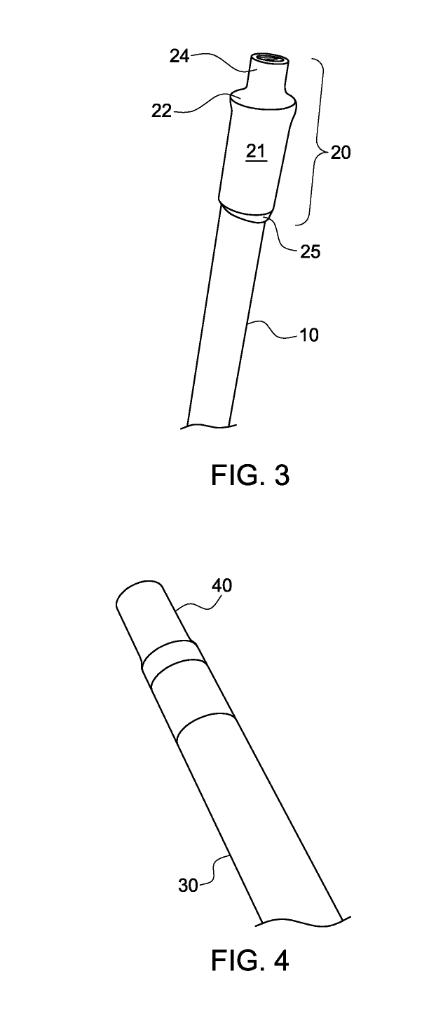

FIG. 3 depicts a disclosed permeation tube 10 sometimes comprising a tube closure system or sheath assembly 20, which may further comprise a body 21 section, distal shoulder 22, proximal shoulder 25, distal cap 24 and other components.

A disclosure wrap or closure system may comprise the application of a resin to a distal portion or emitting end of a permeation tube. The applied resin may be comprised of polyolefin material, Fluorinated ethylene propylene (FEP) resin or other material and may be applied in a solid form or as a liquid applied membrane. In one embodiment a permeation device may have an outside diameter of 0.312 inches and a solid membrane assembly 20 may have an outside diameter of 0.356 inches, but other dimensions are contemplated. The membrane assembly may be fitted or shrunk into place by use of heat, such as heat in the range of 200 to 500 degrees Fahrenheit.

FIG. 4 depicts a disclosed sheath system 40 found upon a permeation tube that may contain Dichloromethane or another payload. The sheath system 40 may be circular or take the shape of a cylinder that is affixed to the permeation tube 30. The circular sheath system may be attached in solid form, and then heated to a temperature in the range of 200 to 500 degrees Fahrenheit to shrink, glue or otherwise secure the sheath.

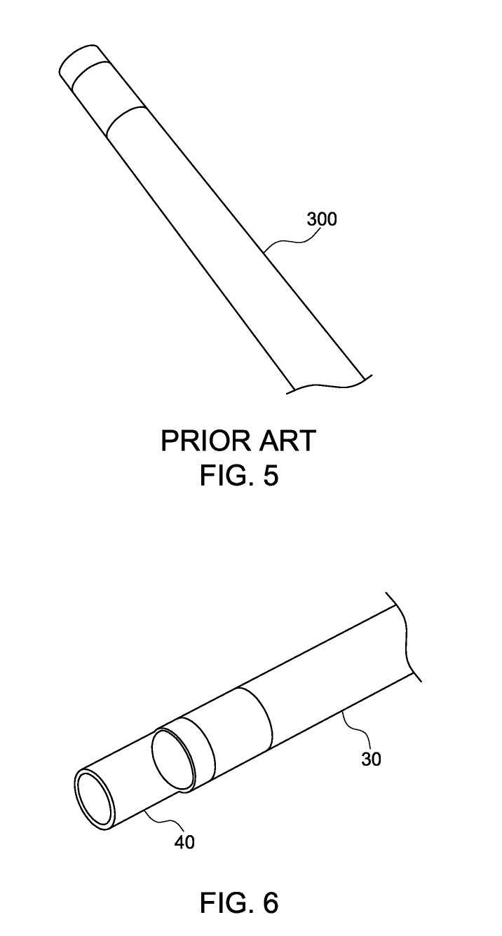

FIG. 5 depicts a permeation tube 300 of the prior art. The permeation tube sometimes containing Dichloromethane or another compound.

FIG. 6 depicts a perspective view of a disclosed sheath system 40, the sheath system shown as being transparent.

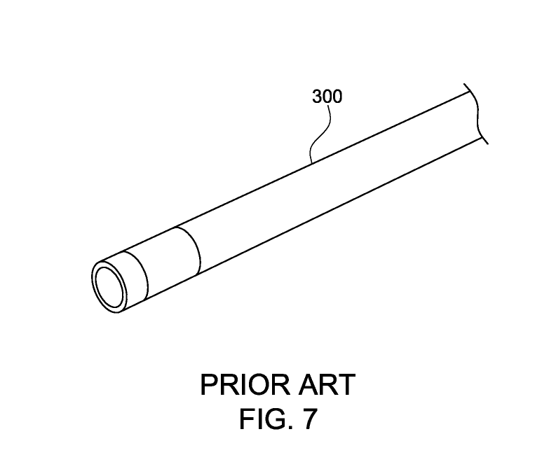

FIG. 7 depicts another view of a prior art permeation tube 300.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

Disclosed embodiments include the following items:

Item 1. A system to improve the useful life of a permeation tube 10, the system comprising:
a) a sheath 20 fastened to a chemical emitting end of a permeation tube.

Item 2. The system of item 1 wherein the sheath comprises a body 21, distal shoulder 22 and distal cap 24.

Item 3. The system of item 2 wherein the sheath further comprises a proximal shoulder 25.

Item 4. The system of item 3 wherein the permeation tube contains Ammonia Crystal.

Item 5. The system of item 3 wherein the sheath comprises Fluorinated ethylene propylene.

Item 6. The system of item 3 wherein the sheath comprises polyolefin.

Item 7. A system to improve the useful life of a permeation tube 30, the system comprising a circular sheath 40 attached to a chemical emitting end of a permeation tube 30.

Item 8. The system of item 7 wherein the sheath is a cylinder.

Item 9. The system of item 7 wherein the permeation tube contains Dichloromethane.

Item 10. The system of item 7 wherein the sheath is comprised of Fluorinated ethylene propylene.

Item 11. The system of item 7 wherein the sheath is comprised of polyolefin.

Item 12. A method of improving the useful life of a permeation device, the method comprising the steps of:
a) attaching a solid sheath assembly 40 over a chemical emitting end of a permeation tube;
b) heating, with a temperature in the range of 200 to 400 degrees Fahrenheit, the solid sheath assembly, the heating contracting the sheath assembly over the chemical emitting end of the permeation tube.

Item 13. The method of item 12 further including the step of using a solid sheath assembly comprising a body, distal shoulder, distal cap and proximal shoulder.

Item 14. The method of item 12 further including the step of using a liquid applied membrane to comprise the sheath assembly.

Item 15. The method of item 12 further including the step of using polyolefin to construct the sheath assembly.

Item 16. The method of item 12 further including the step of using a permeation tube containing Ammonia Crystal.

Item 17. The method of item 12 further including the step of using a permeation tube containing Dichloromethane.

While certain aspects of the invention are presented below in certain claim forms, the inventors contemplate the various aspects of the invention in any number of claim forms.

What is claimed is:

1. A system to improve the useful life of a permeation tube, the system comprising:
a) a sheath fastened to a chemical emitting end of a permeation tube.

2. The system of claim 1 wherein the sheath comprises a body, distal shoulder and distal cap.

3. The system of claim 2 wherein the sheath further comprises a proximal shoulder.

4. The system of claim 3 wherein the permeation tube contains Ammonia Crystal.

5. The system of claim 3 wherein the sheath comprises polyolefin.

6. A system to improve the useful life of a permeation tube, the system comprising a circular sheath attached to a chemical emitting end of a permeation tube.

7. The system of claim 6 wherein the sheath is a cylinder.

8. The system of claim 6 wherein the permeation tube contains Dichloromethane.

9. The system of claim 6 wherein the sheath is comprised of polyolefin.

10. A method of improving the useful life of a permeation device, the method comprising the steps of:
a) attaching a solid sheath assembly over a chemical emitting end of a permeation tube; and
b) heating, with a temperature in the range of 200 to 400 degrees Fahrenheit, the solid sheath assembly, the heating contracting the sheath assembly over the chemical emitting end of the permeation tube.

11. The method of claim 10 further including the step of using a solid sheath assembly comprising a body, distal shoulder, distal cap and proximal shoulder.

12. The method of claim 10 further including the step of using a liquid applied membrane to comprise the sheath assembly.

13. The method of claim 10 further including the step of using polyolefin to construct the sheath assembly.

14. The method of claim 10 further including the step of using a permeation tube containing Ammonia Crystal.

15. The method of claim 10 further including the step of using a permeation tube containing Dichloromethane.
